(19) United States
(12) Patent Application Publication
(10) Pub. No.: US 2025/0105511 A1
(43) Pub. Date: Mar. 27, 2025

(54) ANTENNA COMPOSITE

(71) Applicant: Hirschmann Car Communication (Shanghai) Co. Ltd., Shanghai (CN)

(72) Inventor: Yohei Sakurai, Kanagawa (JP)

(21) Appl. No.: 18/730,859

(22) PCT Filed: Jan. 19, 2023
(86) PCT No.: PCT/JP2023/001509

§ 371 Date: Jul. 22, 2024

(30) Foreign Application Priority Data
Jan. 20, 2022 (JP) 2022-007282

(51) Int. Cl. H01Q 5/328; H01Q 1/48; H01Q 9/04

(52) U.S. Cl. CPC H01Q 5/328; H01Q 1/48; H01Q 9/0421

(57) ABSTRACT

The present disclosure provides an antenna composite comprising two or more types of antennas of mutually different frequency bands, the antennas including a first antenna having a relatively high frequency band, and a second antenna combined with the first antenna and having a relatively low frequency band. The first antenna and the second antenna each comprise a single power-feeding unit, and mutually share a single grounding part.

### TECHNICAL FIELD

The present disclosure relates to an antenna combination.

### BACKGROUND ART

Antennas having various shapes are used in information communication devices for sending and receiving information by means of wireless signals (see Patent Document 1).

### PRIOR ART DOCUMENTS

### Patent Documents

Patent Document 1: JP 2010-259048 A

### SUMMARY OF THE INVENTION

### Problems to be Solved by the Invention

Recent years have seen increased demand for security functions in antennas, together with the function of sending and receiving radio waves. Because of this demand, it is feasible to use two types of antennas having different frequency bands. When an inverted-F antenna is used for each of the antennas, with each comprising one electricity supply portion and one grounding portion, it is necessary to adjust the positions of each of the two grounding portions and each of the two electricity supply portions in order to take account of impedance matching and suppressing radio wave interference between the antennas.

In light of this situation, the objective of the present disclosure lies in providing an antenna combination capable of advantageously providing the characteristics of different types of antennas with a simple structure.

### Means for Solving the Problems

In order to achieve the objective above, the present disclosure provides an antenna combination comprising two or more types of antennas having mutually different frequency bands, wherein
the two or more types of antennas include: a first antenna having a relatively high frequency band, and a second antenna having a relatively low frequency band and combined with the first antenna, and
the first antenna and the second antenna each comprise a single electricity supply portion and share a single grounding portion with each other.

### Advantage of the Invention

The antenna combination according to the present disclosure is capable of advantageously providing the characteristics of different types of antennas with a simple structure.

### BRIEF DESCRIPTION OF THE DRAWINGS

FIG. 1 is an outline oblique view schematically showing an antenna combination according to an embodiment of the present disclosure, as seen from a predetermined direction.

FIG. 2 is an outline oblique view schematically showing the antenna combination according to the embodiment of the present disclosure, as seen from another direction.

FIG. 3 is an outline oblique view schematically showing an antenna combination according to a different embodiment of the present disclosure, as seen from a predetermined direction.

FIG. 4 is an outline oblique view schematically showing the antenna combination according to the different embodiment of the present disclosure, as seen from another direction.

FIG. 5 is a graph showing a relationship of frequency and VSWR in a second antenna.

FIG. 6 is a graph showing a relationship of frequency and VSWR in a first antenna.

FIG. 7 shows a radiation pattern (directional gain) of the second antenna.

FIG. 8 shows a radiation pattern (directional gain) of the first antenna.

FIG. 9 is an outline oblique view schematically showing an antenna combination according to the present disclosure, which has been surface-mounted.

### EMBODIMENTS OF THE INVENTION

An antenna combination according to the present disclosure will be described below with reference to the drawings.

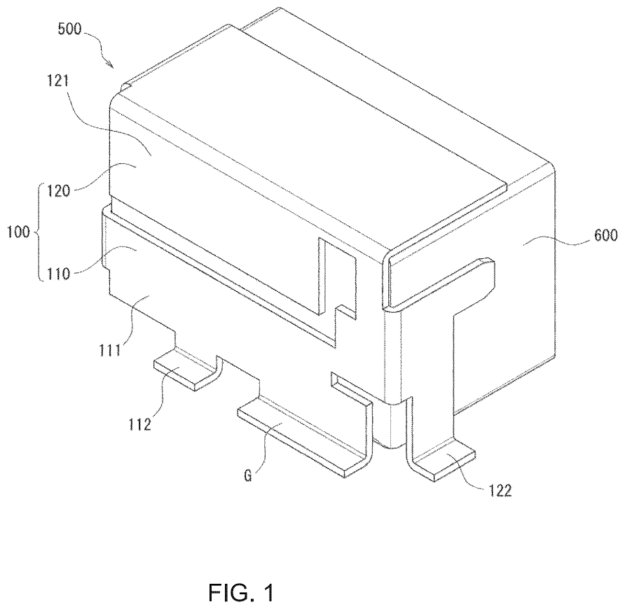

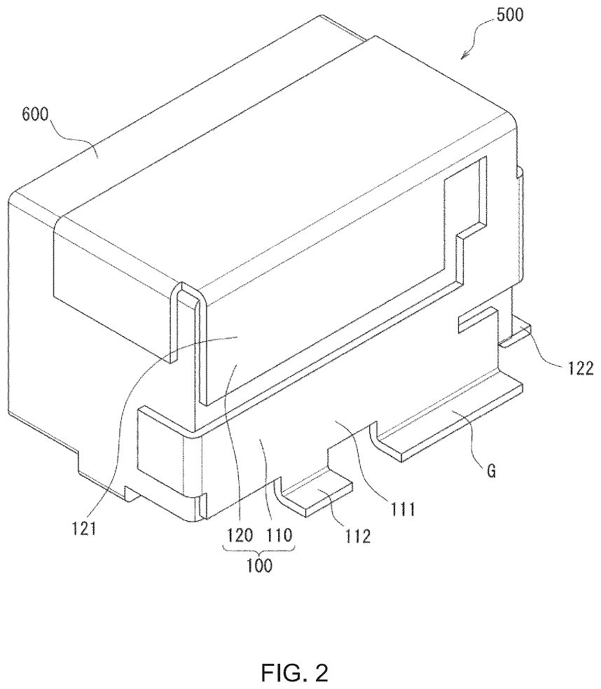

FIG. 1 is an outline oblique view schematically showing an antenna combination according to an embodiment of the present disclosure, as seen from a predetermined direction. FIG. 2 is an outline oblique view schematically showing the antenna combination according to the embodiment of the present disclosure, as seen from another direction.

As shown in FIGS. 1 and 2, an antenna combination 500 comprises a combination of two types of antennas 100 having mutually different frequency bands. The two types of antennas 100 are: a first antenna 110 having a relatively high frequency band, and a second antenna 120 having a relatively low frequency band and combined with the first antenna 110. It should be noted that FIGS. 1 and 2 illustrate two types of antennas 100, but the present disclosure is not limited to this configuration, and two or more types of antennas may be combined.

The first antenna 110 comprises: a first main body portion 111, and a first electricity supply portion 112 and a grounding portion G each extending in a different direction to a direction of longitudinal extension of the first main body portion. The second antenna 120 comprises: a second main body portion 121, and a second electricity supply portion 122 and the grounding portion G each extending in a different direction to a direction of longitudinal extension of the second main body portion. The grounding portion G constitutes a single grounding portion shared between the first antenna 110 and the second antenna 120.

It can be seen from the matters above that, according to the present disclosure, each of the antennas 100 comprises a main body portion, and a single electricity supply portion and the single grounding portion G each extending in a different direction to the direction of longitudinal extension of the main body portion. In addition, according to the present disclosure, the antennas 100 are capable of sharing the single grounding portion G with each other.

It should be noted that the “antenna combination” as referred to herein denotes an element in which the two or more types of antennas are joined to form a single element. The “two or more types of antennas” as referred to herein denote antennas of different types, and do not include antennas of the same type (e.g., Bluetooth antennas). The “antenna” as referred to herein means a component, an apparatus, or a device capable of inter-converting current and radio waves or electromagnetic waves. Alternatively, the “antenna” as referred to herein may be a monopole antenna.

The “electricity supply portion” of the antenna as referred to herein means a point at which electrical power or electrical energy may be supplied from an external structure. There is no particular limitation as to the shape of the electricity supply portion. The electricity supply portion preferably has a plate-shaped form. The electricity supply portion is preferably connected to an electricity supply line or power source wiring of an electronic circuit board. The electricity supply portion preferably has a shape which follows a surface shape of the electronic circuit board at a contact part with the board. The electricity supply portion may have a simple plate-shaped form, or it need not have a plate-shaped form.

The “grounding portion” as referred to herein means a point or a part in contact with an external structure and capable of forming a ground (GND). The grounding portion may be connected to a GND layer or GND wiring of the electronic circuit board, for example. The grounding portion preferably has a shape which follows the surface shape of the electronic circuit board at a contact part with the board. The grounding portion may have a simple plate-shaped form, or it need not have a plate-shaped form.

When antennas each comprising one electricity supply portion and one independent grounding portion are used, it may be necessary to adjust the positions of each of the two grounding portions and each of the two electricity supply portions in order to take account of impedance matching and suppressing radio wave interference between the antennas.

In contrast to this, the present disclosure enables each of the antennas 100 to share the single grounding portion G with each other. That is to say, the grounding portion G functions as a shared grounding portion. This makes it possible to achieve a simpler structure than when antennas each comprising one electricity supply portion and one independent grounding portion are used. The size of the antenna combination 500 can be reduced as a result. That is to say, the antenna combination 500 can be made more compact.

By virtue of achieving this simple structure, it is possible to reduce the number of grounding portions that need to be positionally adjusted to a single one, and the impedance which has been set as a target can be adjusted by adjusting the positions of the two electricity supply portions 100 (corresponding to adjusting a distance between the two electricity supply portions) and by adjusting the position of the single grounding portion G. Adjustments for impedance matching are simplified as a result.

In addition, according to the present disclosure, resonance during use of a predetermined antenna when the other antenna is being used is suppressed, even in a state in which this simple structure has been adopted, where the antenna combination 500 comprises the single grounding portion G (corresponding to the shared grounding portion), which is to say that radio wave interference between the antennas can be suppressed. This makes it possible to stabilize antenna characteristics of the antennas 100. In other words, the present disclosure makes it possible to advantageously provide the antenna characteristics of each of the antennas 100.

It can be seen from the matters above that the antenna combination according to the present disclosure is compact and has more stable antenna characteristics, and can therefore be mounted in a vehicle such as an automobile, a hybrid vehicle, or an electric vehicle, or in an electronic device such as a smartphone or a wearable 11 device, and it can also be used for communication with such electronic devices.

Furthermore, since the antenna combination of the present disclosure can be made more compact, it can also be placed for use on an internal board of a vehicle computer, in particular an engine control unit (ECU), or on an internal board of a smartphone or a wearable device.

It should be noted that “antenna characteristics” as referred to herein mean antenna characteristics in general, and specifically mean characteristics such as impedance and radiation pattern, such as directional gain. “Stabilization” of the antenna characteristics in the present disclosure means that the antenna characteristics do not fluctuate by a large amount. For example, when the antenna characteristic is the radiation pattern, stabilization of the antenna characteristics means that the antenna is omnidirectional, and when the antenna characteristic is the directional gain in particular, stabilization of the antenna characteristics means that the antenna has a radiation pattern with an external shape close to circular in an X-Y plane.

When the antenna characteristic is the impedance, stabilization of the antenna characteristics means that the impedance set as a target is stably exhibited in a desired frequency band or a required frequency band, for example. In the present disclosure, each of the antennas 100 preferably forms a predetermined bandwidth including the impedance set as a target.

Furthermore, each of the antennas 100 may be an inverted-F antenna in the present disclosure. In this case, each of the electricity supply portions and the single grounding portion are spaced apart from each other. By virtue of this configuration, the electricity supply portions of each of the antennas can be mounted on corresponding sides of the electronic circuit board by means of soldering, etc., and the single grounding portion can be grounded to a predetermined electronic circuit board or another structure. Furthermore, when the antennas are inverted-F antennas, the electricity supply portions and the grounding portion may be positioned on the same plane. This may make it possible to achieve omnidirectionality on a horizontal plane. Moreover, “the same plane” as referred to in the present specification indicates that a positional relationship of the electricity supply portions and the grounding portion is a state of being substantially on the same plane or in substantially the same line along a predetermined direction, and the electricity supply portions and the grounding portion do not need to be physically on exactly the same plane.

By this means, the antennas 100 can be used as surface-mount parts. In the present disclosure, “surface-mount part” means a component or a member which can be mounted on a board such as an electronic circuit board, for example, by using surface-mount technology (SMT) which is well-known in this field. The “surface-mount part” may also refer to a surface-mount device (SMD).

As described above, according to the present disclosure, the first antenna 110 is an antenna having a relatively high frequency band, and the second antenna 120 is an antenna having a relatively low frequency band. In one example, the first antenna 110 may be an antenna having a frequency band of 3 GHZ-13 GHZ, preferably 6 GHZ-13 GHz, and more preferably 6 GHZ-8 GHZ (which may be referred to as ultra-wideband (UWB)). Furthermore, in one example, the second antenna 120 may be a Bluetooth antenna having a frequency band of 2 GHz or greater and less than 3 GHZ, and preferably 2.4 GHZ-2.5 GHZ.

By virtue of this configuration, the first antenna 110 has a high frequency and a short wavelength, and a pulse wave can therefore be repeatedly provided to a body being measured which is positioned at a location relatively close to the antenna combination 500. As a result, this configuration can be used in order to accurately measure a distance between (i.e., “range”) the antenna combination 500 and the body being measured.

It should be noted that a distance to an object being measured which is positioned at a location relatively far from the antenna combination 500 is not measured, due to the short wavelength properties of the first antenna 110. Security may therefore be released by ranging only when the body being measured is positioned at a short distance (e.g., around 1 m). As a result, if the body being measured is positioned at a long distance, it is possible to suitably prevent security from being erroneously released. When the antenna combination according to the present disclosure is disposed in a vehicle computer, and especially on an ECU board, it is also possible to suitably deal with the problem of what are known as “relay attacks” if the properties above are utilized. This makes it possible to prevent theft of the vehicle.

Meanwhile, the second antenna 120 has a low frequency and a long wavelength, and radio waves generated on the basis of signals from a module can therefore be used for the purpose of other suitable communication.

Furthermore, in the present disclosure, the bandwidth of the first antenna 110 is preferably wider than the bandwidth of the second antenna 120. A wide bandwidth increases an amount of data communication through the antenna and is also advantageous in that the data speed can be increased. This enables high-speed communication at a short distance (e.g., around 1 m).

As described above, a comparison of the first antenna 110 and the second antenna 120 shows that the first antenna 110 is an antenna having a shorter wavelength and a wider frequency bandwidth. Meanwhile, the second antenna 120 is an antenna having a longer wavelength and a narrower frequency bandwidth. The first antenna 110 can therefore be set at a high impedance without being distanced from a grounding surface G side. Meanwhile, the impedance may decrease when the second antenna 120 is close to the grounding surface G side, so the abovementioned impedance value can be set by distancing the second antenna 120 from the grounding surface G side.

It can be seen from the matters above that the first main body portion 111 of the first antenna 110 may be provided on a proximal side in relation to the grounding portion G, and the second main body portion 121 of the second antenna 120 may be provided on a distal side in relation to the grounding portion G. That is to say, the first main body portion 111 may be positioned on a lower-stage side and the second main body portion 121 may be positioned on an upper-stage side, in a height direction (Z direction) of the antenna combination 100.

The first antenna 110 may have, in the abovementioned frequency band, an impedance within a range of 25Ω-55Ω, and preferably 45Ω-55Ω, and a peak value of impedance preferably with a target of 50Ω. The first antenna 110 is capable of handling ultra-wideband communication by virtue of having an impedance value within the abovementioned range.

In the case above, a part is provided where the first main body portion 111 and the second main body portion 112 are opposingly spaced apart, from the point of view of suppressing resonance of the second antenna 120 when the first antenna 110 is being used, and resonance of the first antenna 110 when the second antenna 120 is being used, i.e., from the point of view of suppressing radio wave interference between the antennas.

Moreover, the first main body portion 111 and the second main body portion may be locally continuous in order to ensure the minimum pathway for the second antenna 120 to comprise the second electricity supply portion 122 extending from the second main body portion 121, and the grounding portion G. In this case, the first main body portion 111 and the second main body portion 121 may be configured in the shape of a letter “U” overall. 36 The grounding portion G is preferably provided between the first electricity supply portion 112 and the second electricity supply portion 122 from the point of view of suitably suppressing radio wave interference between the antennas, in the same way as described above.

The width of the grounding portion G is preferably equal to or greater than the widths of the electricity supply portions 112, 122, from the point of view of a stable arrangement of the antenna combination 100.

A distance of a continuous part between the second electricity supply portion 122 and the grounding portion G is preferably greater than a distance of a continuous part between the first electricity supply portion 112 and the grounding portion G, from the point of view of suitably suppressing radio wave interference between the antennas, in the same way as described above, and of setting a distance between the electricity supply portions 112, 122 in order to adjust the impedance. This configuration may be realized by differences in size of cutout regions on the antenna combination 100.

Furthermore, the antenna combination 500 is preferably capable of being supported by means of support 600.

Providing the support 600 makes it possible to prevent deformation of the antenna combination 500. That is to say, shape stability of the antenna combination 500 and its ability to be self-standing can be improved, enabling the antenna characteristics to be better stabilized.

There is no particular limitation as to the material constituting the support 600, and the support may be formed from a resin (e.g., at least one material selected from the group consisting of polycarbonate (PC), polyphenylene sulfide (PPS), polyamide (PA), syndiotactic polystyrene (SPS), and liquid crystal polymer (LCP)). The antenna characteristics of the antennas can be further stabilized by providing a dielectric inside the support, especially a dielectric having high permittivity, e.g., a resin dielectric having high permittivity.

There is no particular limitation as to the shape of the support 600. For example, the support 600 may have the shape of a box or a quadrangular prism, such as a cube or cuboid, so as to match the shape of the antenna combination 500. Furthermore, the support 600 may equally have another shape such as a triangular prism, a polygonal prism, or a cylinder.

At least one main face of the support is preferably flat. This makes it possible to promote grounding of the antenna combination 500 of the present disclosure to a plate-shaped structure such as an electronic circuit board, for example.

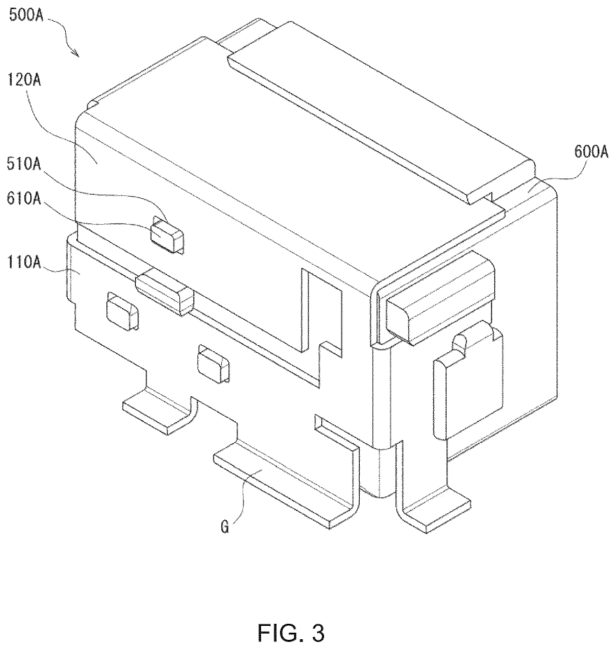

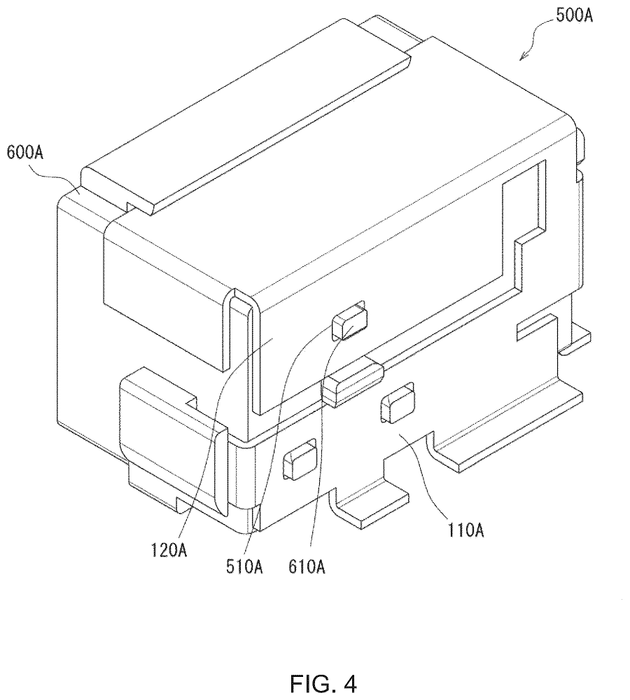

FIG. 3 is an outline oblique view schematically showing an antenna combination according to a different embodiment of the present disclosure, as seen from a predetermined direction. FIG. 4 is an outline oblique view schematically showing the antenna combination according to the different embodiment of the present disclosure, as seen from another direction.

As shown in FIGS. 3 and 4, a support 600A preferably comprises a plurality of protrusions 610A on a predetermined part of a surface. Furthermore, an antenna combination 500A preferably comprises through-holes 510A capable of engaging with each of the protrusions 610A of the support 600A.

By virtue of this configuration, it is possible to achieve a better connection between the antenna combination 500A and the support 600A. This makes it possible to more suitably prevent deformation of the antenna combination 500. As a result, shape stability of the antenna combination 500 and its ability to be self-standing can be further improved, enabling the antenna characteristics to be even better stabilized.

It should be noted that the support is not an essential component in the present disclosure. For example, if the electricity supply portion of the first antenna and the electricity supply portion of the second antenna are provided so as to be capable of being opposingly spaced apart from each other, the antenna combination will be capable of self-standing without the use of a support.

Furthermore, each of the antennas 100 preferably comprises a conductor. Examples of conductors that may be cited include a metal and/or an alloy, etc. Examples that may be cited of elements which may be contained in the metal and/or alloy include: copper (Cu), aluminum (Al), iron (Fe), and zinc (Zn), etc. At least one selected from the group consisting of copper, aluminum, stainless steel and brass is preferably used. The antenna 100 is particularly preferably produced from a brass material.

When the antenna 100 is formed from a material such as a metal and/or an alloy, it may further comprise a plating layer or a surface-treatment layer. The plating layer or the surface-treatment layer preferably comprises an element such as chromium or nickel.

The antenna 100 may also be formed from a ceramic, etc. A ceramic having high permittivity is preferred as the ceramic. For example, a dielectric ceramic which can be used in a chip antenna, etc. may be used without particular limitation, for example. The antenna may be formed from a metal and ceramic composite material, etc.

The antenna combination 500 according to the present disclosure has a width dimension of 5 mm-50 mm, preferably 10 mm-20 mm, for example 12-13 mm, although this is not particularly limiting. The antenna combination 500 according to the present disclosure has a height of 5 mm-30 mm, preferably 8 mm-15 mm, for example 10 mm. The antenna combination 500 according to the present disclosure has a height of 3 mm-30 mm, preferably 5 mm-15 mm, for example 7 mm. The antenna combination 500 according to the present disclosure has a thickness of 1 mm or less, preferably 0.5 mm or less, and more preferably 0.1 mm-0.4 mm, for example. The thickness may be uniform throughout, but it need not be uniform.

### EXAMPLES

Examples of the present disclosure will be described below.

An antenna combination having the following configuration was prepared. The antenna combination 500A which was prepared was surface-mounted on a board 700 (see FIG. 9).

[symbol]

First Antenna
Frequency band of 6 GHZ (6000 MHz)-8.5 GHZ (8500 MHz)
One electricity supply portion [symbol]
   Second Antenna
Frequency band of 2.4 GHZ (2400 MHz)-2.5 GHZ (2500 MHz)
One electricity supply portion [symbol]
   Shared Features of First Antenna and Second Antenna
Single shared grounding portion

### Measurement Result 1 (Relationship of Frequency and VSWR in Each Antenna)

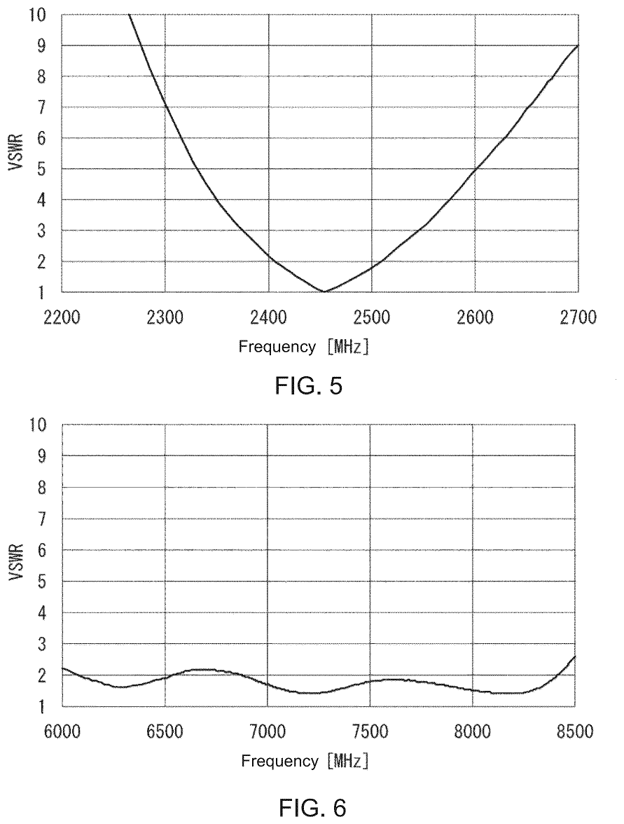

FIG. 5 is a graph showing the relationship of frequency and VSWR in the second antenna. FIG. 6 is a graph showing the relationship of frequency and VSWR in the first antenna.

As shown in FIG. 5, in the frequency band used by the second antenna (frequency band of 2.4 GHZ-2.5 GHZ), VSWR (voltage standing wave ratio: corresponding to a ratio of an incident voltage wave and a reflected voltage wave) was approximately 2. It was clear from this that the second antenna suitably provides the antenna characteristics.

Furthermore, as shown in FIG. 6, in the frequency band used by the first antenna (frequency band of 6 GHZ-8.5 GHz), VSWR (voltage standing wave ratio: corresponding to the ratio of an incident voltage wave and a reflected voltage wave) was approximately 2. It was clear from this that the first antenna suitably provides the antenna characteristics.

### Measurement Result 2 (Radiation Pattern (Directional Gain) of Each Antenna)

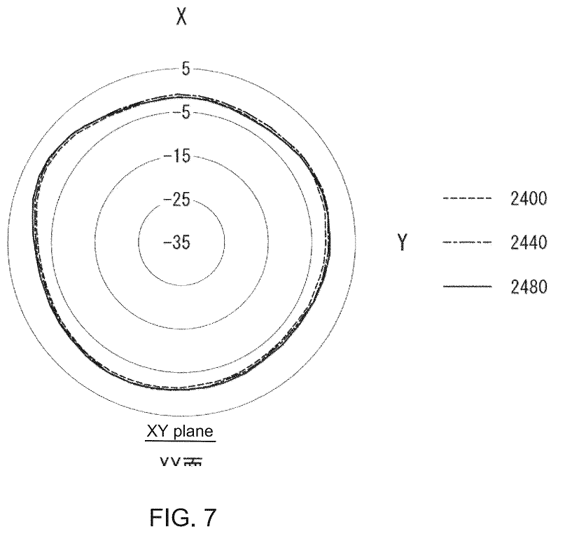

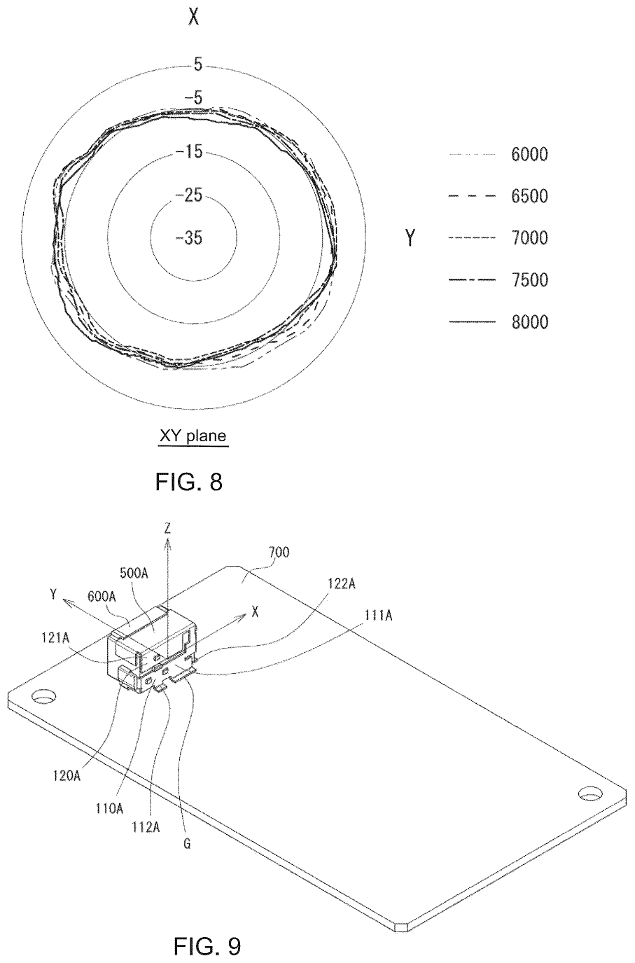

FIG. 7 shows the radiation pattern (directional gain) of the second antenna. FIG. 8 shows the radiation pattern (directional gain) of the first antenna.

As shown in FIG. 7, it was clear that in all of the frequency bands used by the second antenna (2400 MHz, 2440 MHz and 2480 MHz), the second antenna had a radiation pattern in which the external shape (XY plane) of the directional gain was close to circular in the XY plane. It was clear from this that the second antenna suitably provides the antenna characteristics.

As shown in FIG. 8, it was clear that in all of the frequency bands used by the first antenna (6000 MHz, 6500 MHz, 7000 MHz, 7500 MHz and 8000 MHz), the first antenna had a radiation pattern in which the external shape (XY plane) of the directional gain was close to circular. It was clear from this that the first antenna suitably provides the antenna characteristics.

It was clear from this that the antenna characteristics of each of the first antenna 110A and the second antenna 120A can also be stabilized by using the antenna combination 500A comprising the single grounding portion G. It was furthermore clear that omnidirectionality on a horizontal plane can be achieved when the first electricity supply portion 112A of the first antenna 110A, the second electricity supply portion 122A of the second antenna 120A, and the grounding portion G are on the same plane.

It should be noted that there is no particular limitation as to the method for producing the antenna combination according to the present disclosure. For example, when combination 4 the antenna according e present disclosure is produced from a plate-shaped material comprising a metal or alloy, etc., the antenna combination may be produced by cutting and bending the plate-shaped material. Furthermore, the plate-shaped material may also be cut and each of the members may be joined together by welding, etc. When the antenna combination according to the present disclosure is produced from a dielectric ceramic, it may be produced in the same way as with a chip-type ceramic antenna. For example, the antenna combination comprising a dielectric ceramic may be formed on a heat-resistant support by utilizing a printing technique, etc. which is well known in the field of ceramics.

An embodiment of the present disclosure was described above, but the present disclosure is not limited to this embodiment, and various modifications based on the knowledge of those skilled in the art may be made, such as combining the components described above, within a scope that does not depart from the essence of the claims.

The following aspects may be adopted in the present disclosure.

<1>

An antenna combination comprising two or more types of antennas having mutually different frequency bands, wherein
the two or more types of antennas include: a first antenna having a relatively high frequency band, and a second antenna having a relatively low frequency band and combined with the first antenna, and
the first antenna and the second antenna each comprise a single electricity supply portion and share a single grounding portion with each other.
   <2>

The antenna combination as described in <1>, wherein a bandwidth of the first antenna is wider than a bandwidth of the second antenna.

<3>

The antenna combination as described in <1> or <2>, wherein the first antenna and the second antenna are each an inverted-F antenna.

<4>

The antenna combination as described in any of <1> to <3>, wherein the electricity supply portions and the grounding portion are positioned on the same plane.

<5>

The antenna combination as described in any of <1> to <4>, wherein the electricity supply portions and the grounding portion are spaced apart from each other.

<6>

The antenna combination as described in any of <1> to <5>, wherein the width of the grounding portion is equal to or greater than the width of the electricity supply portions.

<7>

The antenna combination as described in any of <1> to <6>, wherein the first antenna has a frequency band of 3 GHz-13 GHz.

<8>

The antenna combination as described in any of <1> to <7>, wherein the second antenna has a frequency band of 2 Hz or greater and less than 3 GHZ.

<9>

The antenna combination as described in any of <1> to <8>, wherein the first antenna comprises a first main body portion provided on a proximal side in relation to the grounding portion, and the second antenna comprises a second main body portion provided on a distal side in relation to the grounding portion.

<10>

The antenna combination as described in <9>, wherein the first main body portion is positioned on a lower-stage side and the second main body portion is positioned on an upper-stage side, in a height direction.

<11>

The antenna combination as described in <9> or <10>, comprising a part where the first main body portion and the second main body portion are opposingly spaced apart.

<12>

The antenna combination as described in any of <9> to <11>, wherein the first main body portion and the second main body portion are locally continuous.

<13>

The antenna combination as described in any of <9> to <12>, wherein the first main body portion and the second main body portion are in the shape of a letter “U” overall.

<14>

The antenna combination as described in any of <1> to <13>, wherein the grounding portion is provided between the electricity supply portion of the first antenna and the electricity supply portion of the second antenna.

<15>

The antenna combination as described in <14>, wherein a distance of a continuous part between the electricity supply portion of the second antenna and the grounding portion is greater than a distance of a continuous part between the electricity supply portion of the first antenna and the grounding portion.

<16>

The antenna combination as described in any of <1> to <15>, wherein the electricity supply portion of the first antenna and the electricity supply portion of the second antenna are provided so as to be capable of being opposingly spaced apart from each other.

<17>

The antenna combination as described in any of <1> to <16>, wherein the first antenna and the second antenna are each surface-mount parts.

<18>

The antenna combination as described in any of <1> to <17>, capable of being supported by means of support.

### INDUSTRIAL APPLICABILITY

The antenna combination according to the present disclosure may be mounted in a vehicle (e.g., a passenger vehicle, a hybrid vehicle, or an electric vehicle, etc.) or in an electronic device (e.g., a smartphone or a wearable device, etc.), and used for communication and ranging, etc.

### CROSS-REFERENCE TO RELATED APPLICATIONS

This application claims priority under the Paris Convention based on Japanese Patent Application No. 2022-007282 (filing date: Jan. 20, 2022, title of the invention: “Antenna combination”), the entire content of which is incorporated herein by way of reference.

Key to Symbols

| | |
|---|---|
| 100, 100A | Antenna |
| 110, 110A | First antenna |
| 111, 111A | First main body portion |
| 112, 112A | First electricity supply portion |
| 120, 120A | Second antenna |
| 121, 121A | Second main body portion |
| 122, 122A | Second electricity supply portion |
| 500, 500A | Antenna combination |
| 600, 600A | Support |
| 700 | Board |
| G | Grounding portion |

1. An antenna combination comprising two or more types of antennas having mutually different frequency bands, wherein
the two or more types of antennas include: a first antenna having a relatively high frequency band, and a second antenna having a relatively low frequency band and combined with the first antenna, and
the first antenna and the second antenna each comprise a single electricity supply portion and share a single grounding portion with each other.

2. The antenna combination as claimed in claim 1, wherein a bandwidth of the first antenna is wider than a bandwidth of the second antenna.

3. The antenna combination as claimed in claim 1, wherein the first antenna and the second antenna are each an inverted-F antenna.

4. The antenna combination as claimed in claim 1, wherein the electricity supply portions and the grounding portion are positioned on the same plane.

5. The antenna combination as claimed in claim 1, wherein the electricity supply portions and the grounding portion are spaced apart from each other.

6. The antenna combination as claimed in claim 1, wherein the width of the grounding portion is equal to or greater than the width of the electricity supply portions.

7. The antenna combination as claimed in claim 1, wherein the first antenna has a frequency band of 3 GHZ-13 GHZ.

8. The antenna combination as claimed in claim 1, wherein the second antenna has a frequency band of 2 Hz or greater and less than 3 GHZ.

9. The antenna combination as claimed in claim 1, wherein the first antenna comprises a first main body portion provided on a proximal side in relation to the grounding portion, and the second antenna comprises a second main body portion provided on a distal side in relation to the grounding portion.

10. The antenna combination as claimed in claim 9, wherein the first main body portion is positioned on a lower-stage side and the second main body portion is positioned on an upper-stage side, in a height direction.

11. The antenna combination as claimed in claim 9, comprising a part where the first main body portion and the second main body portion are opposingly spaced apart.

12. The antenna combination as claimed in claim 9, wherein the first main body portion and the second main body portion are locally continuous.

13. The antenna combination as claimed in claim 9, wherein the first main body portion and the second main body portion are in the shape of a letter “U” overall.

14. The antenna combination as claimed in claim 1, wherein the grounding portion is provided between the electricity supply portion of the first antenna and the electricity supply portion of the second antenna.

15. The antenna combination as claimed in claim 14, wherein a distance of a continuous part between the electricity supply portion of the second antenna and the grounding portion is greater than a distance of a continuous part between the electricity supply portion of the first antenna and the grounding portion.

16. The antenna combination as claimed in claim 1, wherein the electricity supply portion of the first antenna and the electricity supply portion of the second antenna are provided so as to be capable of being opposingly spaced apart from each other.

17. The antenna combination as claimed in claim 1, wherein the first antenna and the second antenna are each surface-mount parts.

18. The antenna combination as claimed in claim 1, capable of being supported by means of support.
